(19) United States
(12) Patent Application Publication
(10) Pub. No.: US 2010/0122733 A1
(43) Pub. Date: May 20, 2010

(54) PRESSURE BIASED MICRO-FLUIDIC VALVE

(75) Inventors: Bryan Grygus, Troy, NY (US); Keith Brown, Clifton Park, NY (US)

Correspondence Address: BURNS & LEVINSON, LLP, 125 SUMMER STREET, BOSTON, MA, 02110, US

(73) Assignee: MTI MicroFuel Cells, Inc., Albany, NY (US)

(21) Appl. No.: 12/274,478

(22) Filed: Nov. 20, 2008

(51) Int. Cl. F17D 1/08; F16K 7/00; F15C 3/00

(52) U.S. Cl. 137/14; 251/331; 137/565.01

(57) ABSTRACT

Embodiments of a valve are disclosed that allow for the control and adjustment of a fluid flow between a valve inlet port and a valve output port as a function of the pressure at the valve inlet port, a pressure at a first pressure input port, and a reference pressure.

### BACKGROUND

These teachings relate generally to pressure biased valves an in particular to pressure biased shutoff valves.

In the prior art, sensing the off state of a system when the fluid source reservoir has the ability to be pressurized would require a check valve having a crack pressure higher than the maximum reservoir pressure. The crack pressure is the nominal pressure drop across the valve during operation. This drop in pressure presents difficulties in small micro-fluidic applications.

What is needed therefore, is a passive shutoff valve that has no maximum pressure, is self regulating, and has a low nominal operating pressure drop.

### SUMMARY

Embodiments of a valve are disclosed that allow for the control and adjustment of a fluid flow between a valve inlet port and a valve output port as a function of the pressure at the valve inlet port, a pressure at a first pressure input port, and a reference pressure. In one embodiment, the valve that includes two ports—a valve inlet port a valve outlet port, and one or more valve seats circumscribing one or more of the two ports. The valve further includes a diaphragm having first and second major surfaces. The first major surface in a closed position acts as a valve face to cover the one or more valve seats preventing fluid communication therebetween. In an open position, the first major surface unseals the valve inlet port and the valve outlet port and allows for fluid communication therebetween. In addition, the valve includes a first pressure inlet coupled to the second major surface of the flexible diaphragm. The first pressure inlet provides a first pressure to said second major surface to attempt to move the diaphragm into the closed position. The valve also includes a reference pressure providing component operatively coupled to the second major surface of said flexible diaphragm. In one instance, fluid communication between said valve inlet and said valve outlet can be controlled and adjusted utilizing in the first pressure and the reference pressure.

Several embodiments of the valve of these teachings are disclosed. Methods for utilizing the valve of these teachings are also disclosed.

### BRIEF DESCRIPTION OF THE DRAWINGS

These and other features, aspects, and advantages of the present teachings will become better understood with regard to the following description, appended claims, and accompanying drawings. The drawings are not necessarily to scale, emphasis instead being placed on illustration of principles of the teachings. The drawings include the following figures:

FIG. 1 is a schematic diagram of one embodiment of the present teachings;

FIG. 2 is a schematic diagram of another embodiment of the present teachings; and

FIG. 3 is a schematic diagram of yet another embodiment of the present teachings.

### DETAILED DESCRIPTION

The present teachings may be understood by the following detailed description, which should be read in conjunction with the attached drawings. The following detailed description of certain embodiments is by way of example only and is not meant to limit the scope of the present teachings.

“Diaphragm” as used herein refers to an element capable of being manipulated such that it can at least partially block the passage of fluid flow between an input port and an output port in a first position and permit the flow of fluid between an input port and an output port in a second position. An “actuating force” is a force that is capable of moving the diaphragm between the first and second positions. A “valve seat” is an element designed to accept a portion of the diaphragm when in the first position, thereby blocking fluid flow from the respective port.

The present teachings relate the use of scaled valves to control fluid flow. While the present teachings are not limited to a particular sealing method, in one embodiment, an actuating force pushes a diaphragm against or away from a valve seat to restrict fluid flow and the diaphragm is then sealed to or removed from the valve seat.

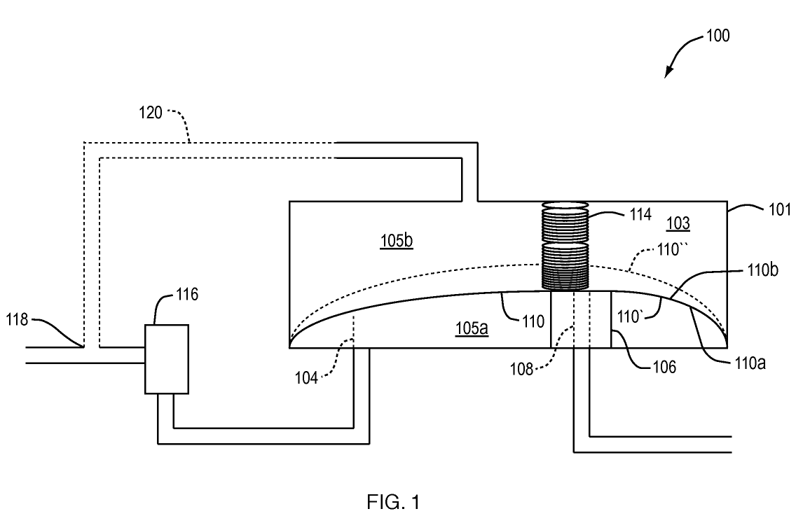

FIG. 1 depicts one embodiment of a valve of these teachings. In particular, a valve 100 includes a valve outlet seat 106 that extends within the interior 101 of the valve 100. The valve outlet seat circumscribes a valve outlet port 108 that may be connected to an (or one or more) ancillary apparatus to which flow is to be regulated. Typically, the valve 100 is constructed of molded plastic material, although other materials may be used as well. The valve 100 further includes a valve inlet port 104 that may be connected to a fluid or gas source from which flow is to be regulated. The valve 100 also includes a diaphragm 110 that includes a first major surface 110a and a second major surface 110b. The diaphragm 110 may have a first position 110′ and a second position 110″.

In the first position, the first major surface 110a covers the valve outlet seat 106 and the valve outlet port 108. In this position, the first major surface acts a closed valve face and prevents fluid communication between valve inlet port 104 and the valve outlet port 108.

In the second position, the first major surface 110a uncovers the valve outlet seat 106, valve outlet port 108; the valve inlet port 104 is also not covered by the first major surface 110a. In this position, the first major surface acts an open valve face and allows fluid communication between valve inlet port 104 and the valve outlet port 108.

The valve 100 also includes a first pressure inlet 112. The first pressure inlet 112 provides for pressure to be exerted against the second major surface 110b of the diaphragm 110. In the embodiment depicted in FIG. 1, a reference pressure providing component 114 is also included.

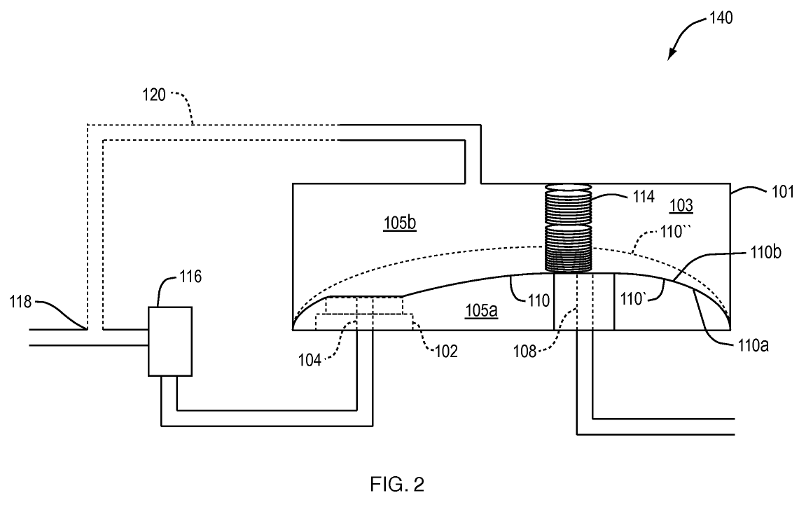

FIG. 2 depicts another embodiment of a valve of the pressure biased micro-fluidic valve. In particular, a valve 140 includes a valve inlet seat 102 that extends within the interior 101 of the valve 140. The valve inlet seat circumscribes the valve inlet port 104 that may be connected to fluid or gas source from which flow is to be regulated. The valve 140 further includes a valve outlet port 108 that may be connected to one or more ancillary apparatus to which flow is to be regulated. The valve 100 also includes a diaphragm 110 that includes a first major surface 110a and a second major surface 110b. The diaphragm 110 may have a first position 110 and a second position 110″.

In the first position, the first major surface 110a covers both the valve inlet seat 102 and valve inlet port 104. In this position, the first major surface acts a closed valve face and prevents fluid communication between valve inlet port 102 and the valve outlet port 108.

In the second position, the first major surface 110a uncovers the valve inlet seat 102, valve inlet port 104; the valve outlet port 108 is also not covered by the first major surface 110a. In this position, the first major surface acts an open valve face and allows fluid communication between valve inlet port 102 and the valve outlet port 108. The valve 100 also includes a first pressure inlet 112 and a reference pressure providing component 114.

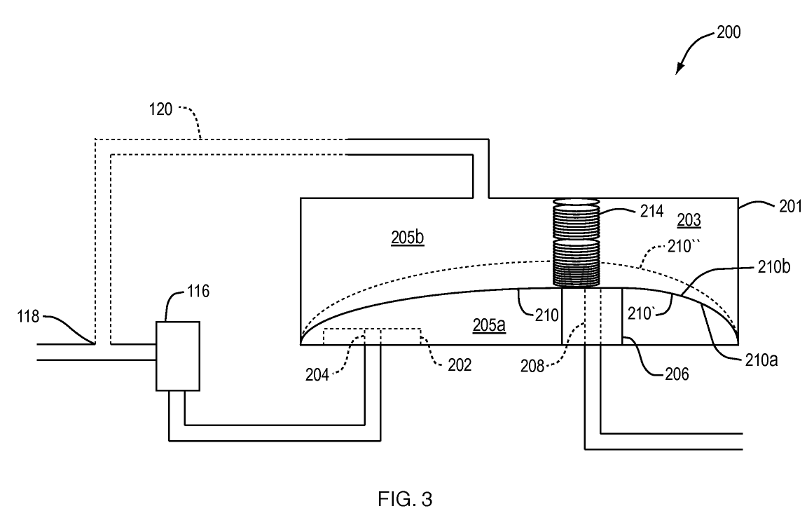

FIG. 3 depicts yet another embodiment of a valve of the pressure biased micro-fluidic valve. In particular, a valve 200 includes a valve inlet seat 202 that extends within the interior 201 of the valve 200. The valve inlet seat circumscribes a valve inlet port 204 that may be connected to fluid or gas source from which flow is to be regulated. Typically, the valve 200 is constructed of molded plastic material, although other materials are also within the scope of these teachings. The valve 200 further includes a valve outlet seat 206 that circumscribes a valve outlet port 208 that may be connected to one or more ancillary apparatus to which flow is to be regulated. The valve 200 also includes a diaphragm 210 that includes a first major surface 210a and a second major surface 210b. The diaphragm 210 may have a first position 210′ and a second position 210″.

In the first position, the first major surface 210a covers both the valve inlet seat 202, valve inlet port 204, valve outlet seat 206, and valve outlet port 208. In this position, the first major surface acts a closed valve face and prevents fluid communication between valve inlet port 202 and the valve outlet port 208.

In the second position, the first major surface uncovers both the valve inlet seat 202, valve inlet port 204, valve outlet seat 206, and valve outlet port 208. In this position, the first major surface acts an open valve face and allows fluid communication between valve inlet port 202 and the valve outlet port 208.

The valve 200 also includes a first pressure inlet 212. The first pressure inlet 212 provides for pressure to be exerted against the second major surface 210b of the diaphragm 210. In the embodiment depicted in FIG. 3, a reference pressure providing component 214 is also provided. In this embodiment, the movement of diaphragm 210 from a closed position 210′ to an open position 210″ is a function of the various pressures applied to each of the first and second major surfaces of the diaphragm 210.

In the embodiments described hereinabove, the movement of diaphragm 110 (or 210 in FIG. 3) from a closed position 110′ to an open position 110″ is a function of the various pressures applied to each of the first and second major surfaces of the diaphragm 110.

In one embodiment, each of the first and second surfaces has substantially equal surface areas. As is known, force=pressure*surface area, or F=P*A. In this embodiment, the forces on the first and second major surfaces become:

Pₒᵤₜ*A_{first}≧(Pᵢₙ+P_{ref})*A_{second} (1)

where A_{first} is the surface area of the first major surface, A_{second} is the surface area of the second major surface, Pₒᵤₜ is the pressure resulting from flow from the valve inlet port 104 (or 204, FIG. 3), Pᵢₙ is the pressure resulting from flow from the first pressure inlet 112 (212, FIG. 3) and P_{ref} is the pressure resulting from the reference pressure providing component 114 (214, FIG. 3). In one embodiment, A_{first} is substantially equal to A_{second} (A_{first}=A_{second}), equation (1) simplifies to:

Pₒᵤₜ≧Pᵢₙ+_{Pref}. (2)

The above conditions is the condition in which the diaphragm moves from position 110′ to 110″ and moves away from the valve inlet port and valve outlet port and allows fluid communication therebetween.

It should be noted that while the reference pressure has been depicted as a pressure, for example provided by a separate pump or other pressure generating element. However, the reference pressure may also be provided by a force, for example provided by a spring, a bimetallic material, or the force may be generated by the elasticity of the diaphragm 110 itself.

In another embodiment, the first and second surfaces have unequal surface areas. As is known, force=pressure*surface area, or F=P*A. In this embodiment, the forces on the first and second major surfaces become:

Pₒᵤₜ*A_{first}≧(Pᵢₙ+P_{ref})*A_{second} (3)

where A_{first} is the surface area of the first major surface, A_{second} is the surface area of the second major surface. Thus, the control of the fluid flow between the valve inlet port and the valve outlet port may be a function of Pᵢₙ, Pₒᵤₜ and the ratio of the first and second surface areas.

The condition given by equations (3) hereinabove is the condition in which the diaphragm moves from position 110′ to 110″ and moves away from the valve inlet port and valve outlet port and allows fluid communication therebetween. In this way, the valve operation may be adjusted to open at pressures that are specific to a particular system by adjusting the first and second surface areas accordingly.

As above, it should be noted that while the reference pressure has been depicted as a pressure, for example, as provided by a separate pump or other pressure generating element. However, the reference pressure may also be generated by a force, for example provided by a spring, a bimetallic material, or the force may be generated by the elasticity of the diaphragm 110 itself.

FIGS. 1, 2, 3 also depict the valve 100 (140, 200) for use in a system. In the depicted system, the first pressure inlet 112 is connected to a fluid line 120 that samples the input to the pump 116 via connection 118. In this embodiment, the pressure at reference port 112 is equivalent to the pump 116 input pressure. Thus when the pump 116 is not operational, the first and second surface areas may be adjusted such that reference pressure and/or the input pressure at inlet 112 will be sufficient to ensure that the diaphragm 110 (or 210, FIG. 3) is in the closed position 110′ (or 210″, FIG. 3) and prevents any fluid communication between the valve inlet port 104 (or 204, FIG. 3) and the valve outlet port 108 (or 208, FIG. 3). Only after the pump 116 is operational, will the force exerted on the first major surface of the diaphragm 110 (or 210, FIG. 3) be sufficient to move the diaphragm 110 (or 210, FIG. 3) to the open position 110″ (or 210″, FIG. 3) and allow fluid communication between valve input port 104 (or 204, FIG. 3) and valve output port 108 (or 208, FIG. 3).

This embodiment is particularly useful in a system in which the valve and pump are located within the fluid supply reservoir or in a fluid supply cartridge. In this instance, the pump will be at rest, i.e., non-operational in the detached state and the valve 100 will prevent fluid from leaving the fluid supply cartridge. However, embodiments of the valve of these teachings can also be used when the valve and pump are separately connected to the fuel reservoir or cartridge. By operation of the embodiments disclosed hereinabove, flow into the valve outlet port is substantially prevented when the pump is inactive.

By careful adjustment of the various parameters, for example the size of inlet seat 102, the size of the valve inlet port 104, the size of the valve outlet seat 106, the size of the valve outlet port 108 or the size of the first and second surface areas, the pressure at first pressure inlet may be used to control the fluid flow between the valve input port 104 and valve output port 108. By using the pressure at the first pressure inlet as the control variable and the fluid volume or flow rate as a controlled variable, a feedback control system may be designed that allows for using the valve 100 as a flow control device.

It should be noted that while several embodiments of the reference pressure generating component have been described, these teachings are not limited to only those embodiments.

While the present teachings have been particularly shown and described with references to preferred embodiments thereof, it will be understood by those skilled in the art that various changes in form and details may be made therein without departing from the spirit and scope of the teachings as defined by the appended claims. All the features disclosed in this specification, including any accompanying claims, abstract, and drawings, may be replaced by alternative features serving the same, equivalent or similar purpose, unless expressly stated otherwise.

What is claimed is:

1. A valve comprising:
two ports, a valve inlet port and a valve outlet port;
at least one valve seat circumscribing at least one of said two ports;
a diaphragm having first and second major surfaces said first major surface acting as a valve face, wherein said first major surface is said configured and arranged to cover said at least one valve seat, said first major surface having an open position in for providing fluid communication between said valve inlet port and said valve outlet port and a closed position for preventing fluid communication between said valve inlet port and said valve outlet port;
a first pressure inlet coupled to said second major surface of said flexible diaphragm, wherein said first pressure inlet provides a first pressure to said second major surface;
a reference pressure providing component operatively coupled to said second major surface of said flexible diaphragm;
said first and second major surface having first and second surface areas, respectively;
wherein said fluid communication between said valve inlet port and said valve outlet port occurs when an output force exerted by a valve inlet against the first major surface exceeds an input force exerted by a combination of a reference pressure and the first pressure against the second major surface, said reference pressure being generated by said reference pressure generating component.

2. The valve of claim 1 wherein said at least one valve seat comprises one valve seat; said one valve is circumscribing said valve outlet port.

3. The valve of claim 1 wherein said at least one valve seat comprises one valve seat; said at least one valve seat circumscribing said valve inlet port.

4. The valve of claim 1 wherein said at least one valve seat comprises two valve seats; one of said at least two valve seats circumscribing said valve inlet port; another one of the least to valve seats circumscribing said valve outlet port.

5. The valve of claim 1 wherein an area of first surface is substantially equal to an area of the second surface.

6. The valve of claim 5 wherein said fluid communication occurs when a valve inlet pressure is at least equal to a sum of the first pressure and the reference pressure, said valve inlet pressure being a pressure generated from said valve inlet port.

7. The valve of claim 1 wherein an area of first surface is not equal to an area of the second surface.

8. The valve of claim 7 wherein the output force is equal to a valve inlet pressure multiplied by the area of first surface, said valve inlet pressure being a pressure generated from said valve inlet port; the input force is equal to the sum of the first pressure multiplied by the area of the second surface and the reference pressure multiplied by the area of the second surface; and wherein said fluid communication occurs when said output force is at least equal to the input force.

8. The valve of claim 7 wherein the reference pressure is generated by a predetermined reference force; wherein the output force is equal to a valve inlet pressure multiplied by the area of first surface, said valve inlet pressure being a pressure generated from said valve inlet port; the input force is equal to the sum of the product of the first pressure and the area of the second surface and the predetermined reference force; and wherein said fluid communication occurs when said output force is at least equal to the input force.

9. The valve of claim 1 wherein said reference pressure generating component comprises a spring coefficient of said diaphragm.

10. The valve of claim 1 wherein said reference pressure generating component comprises an external spring.

11. A system for regulating fluid flow comprising:
a pump having an input receiving an input fluid having a first pressure and an output providing output fluid having a second pressure;
a valve comprising:
two ports, a valve inlet port and a valve outlet port;
at least one valve seat circumscribing at least one of said two ports;
a flexible diaphragm having first and second major surfaces; said first major surface acting as a valve face, wherein said first major surface is configured and arranged to cover said at least one valve seat, said first major surface having an open position for providing fluid communication between said valve inlet port and said valve outlet port and a closed position for preventing fluid communication between said valve inlet port and said valve outlet port;
a first pressure inlet coupled to said second major surface of said flexible diaphragm, wherein said first pressure inlet provides a first pressure to said second major surface;
a reference pressure generating component operatively coupled to said second major surface of said flexible diaphragm;
said first and second major surface having first and second surface areas, respectively;
said input of said pump being in communication with the first pressure inlet of the valve; a pressure resulting from the first pressure inlet being substantially said first pressure;
the output of the pump being in fluid communication with the valve inlet port; said valve inlet port receiving a portion of the output fluid of the pump at the second pressure; a pressure resulting from said valve inlet port being substantially said second pressure; fluid communication between said valve inlet port and said valve outlet port occurring when an output force exerted by a valve inlet against the first major surface exceeds an input force exerted by a combination of a reference pressure and the first pressure against the second major surface, said reference pressure being generated by said reference pressure generating component.

12. The system of claim 11 wherein said at least one valve seat comprises one valve seat;
said one valve is circumscribing said valve outlet port.

13. The system of claim 11 wherein said at least one valve seat comprises one valve seat;
said at least one valve seat circumscribing said valve inlet port.

14. The system of claim 11 wherein said at least one valve seat comprises two valve seats;
one of said at least two valve seats circumscribing said valve inlet port; another one of the least to valve seats circumscribing said valve outlet port.

15. The system of claim 11 wherein said reference pressure generating component comprises a spring coefficient of said diaphragm.

16. The system of claim 11 wherein said reference pressure generating component comprises an external spring.

17. A method for substantially preventing flow from a pump went the pump is inactive, the method comprising the steps of:
providing a valve, the valve comprising:
a valve inlet port operatively connected to receive flow from the pump;
a valve outlet port;
a diaphragm comprising a first major surface and a second major surface; a pressure inlet port operatively connected to an input of the pump; said pressure inlet port providing a pressure exerted against said second major surface; said exerted pressure being substantially equivalent to an input pressure of the pump; a reference pressure also being exerted against said second major surface; said first major surface configured and arranged to cover said valve inlet port and said valve outlet port;
allowing fluid communication between the valve inlet port and the valve outlet port when an output force exerted by flow from the valve inlet port against the first major surface exceeds an input force exerted by the combination of the reference pressure and said exerted pressure against the second major surface;
whereby flow into the valve outlet port is substantially prevented when the pump is inactive.
